(19) United States
(12) Patent Application Publication
(10) Pub. No.: US 2005/0275173 A1
(43) Pub. Date: Dec. 15, 2005

(54) Creeper with tool case & merchandising method

(76) Inventors: Hector Ray Hernandez, Fullerton, CA (US); Chin-Kun Cheng, Taichung (TW)

Correspondence Address: CONNORS ASSOCIATES, 1600 DOVE ST, SUITE 220, NEWPORT BEACH, CA, 92660, US

(21) Appl. No.: 11/143,105

(22) Filed: Jun. 2, 2005

Related U.S. Application Data
(62) Division of application No. 10/284,749, filed on Oct. 31, 2002, now Pat. No. 6,902,174.
(60) Provisional application No. 60/347,644, filed on Jan. 11, 2002.

(51) Int. Cl. B25H 5/00

(52) U.S. Cl. 280/32.6

(57) ABSTRACT

A creeper adapted to store tools in a compartment.

### RELATED PATENT APPLICATION & INCORPORATION BY REFERENCE

This application is a utility application based on U.S. provisional patent application Ser. No. 60/347,644 entitled “Molded Creeper with Tools,” filed Jan. 11, 2002. This related application is incorporated herein by reference and made a part of this application. If any conflict arises between the disclosure of the invention in this utility application and that in the related provisional application, the disclosure in this utility application shall govern. Moreover, Applicants incorporate herein by reference any and all U.S. patents, U.S. patent applications, and other documents cited or referred to in this application or cited or referred to in the U.S. patents and U.S. patent applications incorporated herein by reference.

### DEFINITIONS

The words “comprising,” “having,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND OF INVENTION

A mechanic is often required to work with tools on the underside of an automobile or other vehicle to perform maintenance. It has been known to use devices called creepers that include a deck mounted on wheels. A creeper enables the mechanic to move and work underneath an automobile while lying in a supine position on the creeper.

### SUMMARY OF INVENTION

This invention, with its several desirable features, is summarized in the CLAIMS that follow. After reading the following section entitled “DETAILED DESCRIPTION,” one will understand how the features of this invention provide its benefits. These benefits include, but are not limited to: providing a convenient way to store tools in a creeper, easy access to tools while using a creeper, a more comfortable surface on which to lie while using a creeper, and an improved method of merchandising tools and creepers at a point of sale.

Some, but not all, of the features of this invention are:

One, the creeper includes a compartment adapted to hold tools. The creeper may be sold with the tools stored in the compartment as a single unit at a point-of-sale. Alternately, the creeper and the tools may be sold separately, or both separated but contained within the same packaging. Typically, the creeper is substantially longer than wide, having corners with one wheel at or near each corner. The wheels may be mounted to swivel.

Two, the creeper includes a deck comprising a topside and an underside. The wheels extend outward from the underside and elevate the deck above ground level substantially horizontally a predetermined distance, typically from about 2 to about 5 inches. The compartment may be beneath the underside. The compartment may have an interior adapted to hold tools either in (1) predetermined locations or (2) loosely or (3) both ways. This compartment may be formed by sidewalls and a bottom wall. In one embodiment, the compartment has an opening in the topside to provide access to any tool in the interior.

Three, in one embodiment, the opening is covered with a lid that is moveable between an open position and a closed position. The lid may be detachably mounted to the deck, or it may be mounted to the deck by a hinge member. In this one embodiment, an external side of the lid lies substantially flush with the topside of the deck when the lid is in the closed position.

Four, in one embodiment, the creeper has a body molded from a plastic material with the deck and compartment being integral. The compartment could, however, be constructed as a separate unit and connected to the deck. When the body is made of plastic material and blow molded, it has a substantial portion that is hollow. This reduces the weight of the creeper and reduces costs of manufacture.

Five, the deck may include reinforcing members. Such reinforcing members may be in the topside or underside or both. Examples of such reinforcing members are a series of parallel wedge elements along an inner sidewall of the compartment, a series of ribs extending lengthwise along the underside, a series of ribs extending crosswise along the underside, a plurality of parallel ridges extending lengthwise along the lid, and a plurality of parallel ridges extending lengthwise along the topside of the deck. These reinforcing members impart structural rigidity to the deck, their use is desirable when the body is blow molded and has a hollow portion.

Six, in one embodiment, the sidewalls of the compartment have a predetermined height that is less than the predetermined distance that the wheels elevate the deck above ground level, so that the bottom wall of the compartment is above ground level. Typically, the deck is sufficiently rigid to carry a load of at least 250 pounds and the compartment's bottom wall is above ground level at least 1 inch when carrying this load.

Seven, the compartment may include a tray section with indentations therein conforming to the shape of individual tools. When the tools are sold with the creeper, the individual tools are seated in these indentations. The compartment may also include a well section suitable for storing loose tools.

Eight, the creeper has a head end and a foot end. In one embodiment, the compartment is closer to the foot end than the head end. There may be a headrest on the topside near the head end of the deck. This headrest may be detachably mounted to the deck or molded into the topside of the deck.

Nine, the topside may have a surface including contours that conform the deck's surface configuration more closely to the back of a user lying with his or her back on the deck. For example, there may be a pair of contours, one contour on each side of the headrest. These contours each have a predetermined outline corresponding to one shoulder of a user lying on his or her back on the topside of the deck with his or her head on the headrest. Moreover, the topside may also have a pair of contours near the foot end, one contour near each opposed side of the deck. These contours each have a predetermined outline corresponding to one leg of a user lying on his or her back on the topside of the deck with his or her head on the headrest.

A method of merchandising tools with a creeper at a point-of-sale is also provided. This method includes (a) providing the creeper with a compartment, and (b) storing tools within the compartment such that the tools and creeper are sold together as a unit at a point-of-sale. In this method, the compartment may include a tray section with indentations therein conforming to the shape of individual tools with the individual tools seated in the indentations.

### DESCRIPTION OF DRAWINGS

The preferred embodiments of this invention, illustrating all its features, will now be discussed in detail. These embodiments depict the novel and non-obvious creeper and merchandising method of this invention as shown in the accompanying drawings, which are for illustrative purposes only. These drawings include the following figures (FIGS.), with like numerals indicating like parts:

FIG. 1 is a top plan view of a creeper according to one embodiment of the invention.

FIG. 2 is a side view of a creeper according to the embodiment of the invention shown in FIG. 1.

FIG. 3 is a perspective view of a creeper according to the embodiment of the invention shown in FIG. 1.

FIG. 4 is a perspective view of a creeper according to the embodiment of the invention shown in FIG. 1 with caster wheels and a hinged lid for a tool compartment exploded.

FIG. 5 is a cross-sectional view of the creeper taken along line 5-5 of FIG. 3.

FIG. 5A is a fragmentary, enlarged cross-sectional view of the foot end of the creeper shown in FIG. 1 with the lid removed.

FIG. 6 is a perspective view of a creeper according to an embodiment of the invention employing a detachable headrest.

FIG. 7 is a perspective view of a creeper according to an embodiment of the invention employing a detachable lid.

FIG. 8 is a bottom view of the creeper shown in FIG. 1 with the caster wheels removed.

FIG. 9 is an elevational view of the head end of the creeper shown in FIG. 1.

### DETAILED DESCRIPTION

A creeper according to this invention may be assembled from individual plastic or metallic components or it may be made from conventional plastic materials such as, for example, polypropylene using conventional injection or blow molding manufacturing techniques. Blow molding is desirable because of lower tooling costs.

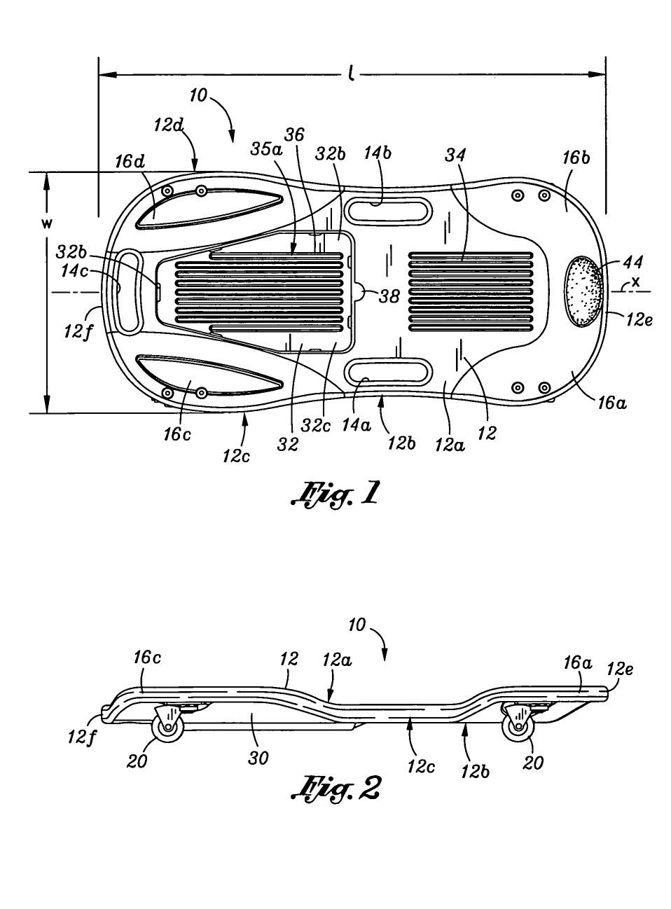

Referring to FIGS. 1-5, in this one illustrative embodiment, the creeper 10 is made using blow molding manufacturing techniques. It comprises a deck 12, wheels 20, and a tool storage compartment 30. The deck 12 has a topside 12a, an underside 12b, a left side 12c, a right side 12d, a head end 12e, and a foot end 12f. The sides 12c and 12d of the deck 12 are longer than the ends 12e and 12f of the deck 12, so that the deck has an overall substantially rectangular shape with a width w from about 18 to about 24 inches and a length 1 from about 34 to about 44 inches. The deck 12 may have one or more handles 14a, 14b, 14c, for example, in the form of elongated, oblong apertures through the deck 12, to allow a user to hold the creeper 10. The handles 14a and 14b may be located near the left side 12c and right side 12d, respectively. In the embodiment shown, the handle 14c is at the foot end 12f of the deck 12. In another embodiment, another handle (not shown) may be located at the head end 12e of the deck 12. The creeper 10 may be hung during storage by any of the handles 14a, 14b, 14c.

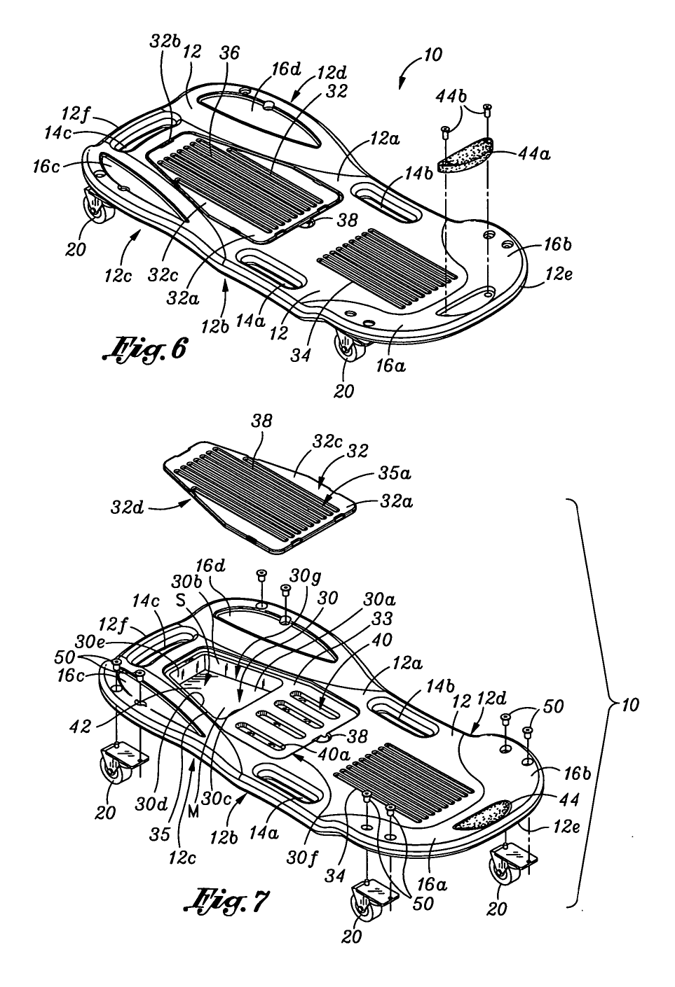

There is a headrest 44 on the deck. Such a headrest 44 may be molded into the topside 12a of the deck 12 as shown best in FIG. 1, permanently affixing it to the topside 12a. Or, a headrest 44a may be a separate unit that is detachably mounted by screws 44b to the deck 12 as shown best in FIG. 6. Typically, the headrest, either headrest 44 or headrest 44a, is centrally located on the topside 12a near the head end 12f along a longitudinal axis X of the creeper 10. The headrest 44 supports the head of a user when the user is lying in a supine position on the deck 12 with his or her head on the headrest and his or her feet near the foot end 12f.

In one embodiment, a set of shoulder rests are provided by contours 16a, 16b and a set of leg rests are provided by contours 16c, 16d, each set located on the topside 12a of the deck 12. The shoulder rests contours 16a and 16b are located near the head end 12e of the deck 12, each near one of the sides 12c and 12d of the deck 12 on opposite sides of the headrest 44. The outline of the shoulder rests contours 16a and 16b may each be shaped to correspond to the contour of a user's shoulder when the user is lying on the creeper 10 with his or her head on the headrest 44 as discussed above. The leg rests contours 16c and 16d may be located near the foot end 12f of the deck 12, near the left side 12c and the right side 12d of the deck 12, respectively. The leg rests contours 16c and 16d may be shaped to correspond to the back of a user's leg when the user is lying on the creeper 10 with his or her head on the headrest 44 and the user's left leg resting on the contour 16c and the user's right leg resting on the contour 16d. The shoulder rests contours 16a, 16b and the leg rests contours 16c, 16d provide additional comfort to a user because the contours 16a, 16b, 16c and 16b provide a wider support area conforming to the shape of the portion of the user's body, i.e. shoulders and legs, in contact with the topside 12a as compared to a non-contoured surface. The contours 16a, 16b, 16c and 16b are typically formed from plastic material that is molded to provide the desired shape of the contour.

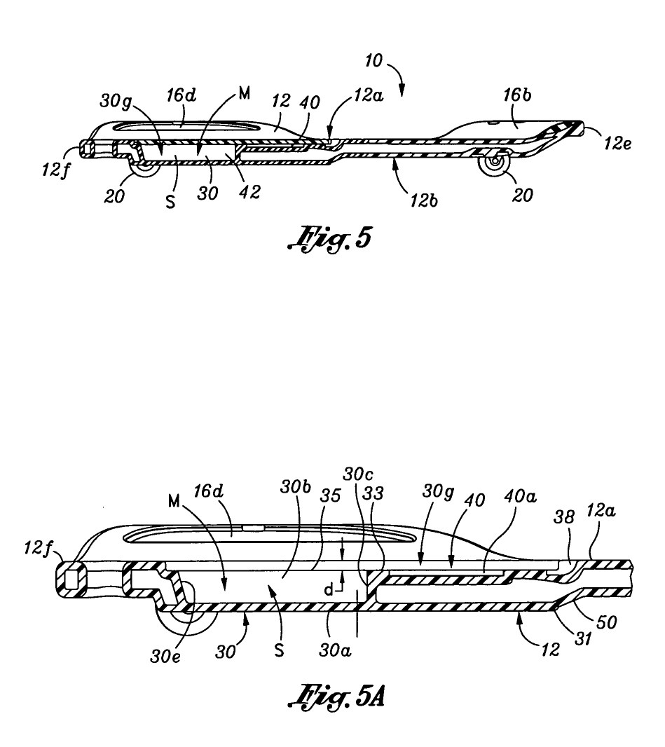

In one embodiment, the compartment 30 may be a separate unit and attached for example by bolts (not shown) to the deck 12. In the embodiments illustrated, the compartment 30 and the deck 12 are integrally molded from the same plastic material. The compartment 30 provides an interior space S (FIGS. 4 and 5) having an opening 30g in the topside 12a of the deck 12. The interior space S includes a well 42 and a tray section 40, typically recessed below the topside 12a. The well 42 has an open mouth M surrounded by a recessed U-shaped rim 35. The tray section 40 includes a recessed, substantially flat, planar ledge 33 having a one or more indentations 40a therein. The recessed U-shaped rim 35 and planar ledge 33 are in the same plane and both support a lid 32 seated in the opening 30g. The lid 32 has substantially the same configuration as the opening 30g. In this embodiment, both are six-sided polygons, with the lid having dimensions essentially the same as those of the opening 30g so the lid snaps into position and fits snugly within the opening when it is resting on the rim 35 and ledge 33. When the lid 32 is so seated, its external surface 35a is substantially flush with the topside 12a of the deck 12. Both the well 42 and the tray section 40 may each be adapted to hold tools.

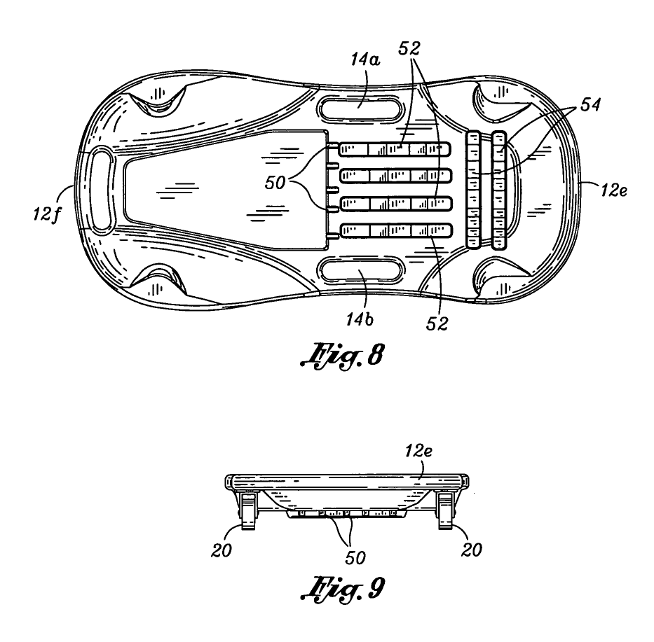

The well 42 includes a bottom wall 30a and four sidewalls 30b, 30d, 30e, 30f extending from the bottom wall 30a to form the open mouth M of the well. The sidewalls 30b and 30d of the well 42 may taper outward, and the sidewall 30e may taper outward towards the foot end 12f of the deck 12. The bottom wall 30a forms a portion of the underside 12b of the deck 12, extending beyond the well to terminate in an inner compartment sidewall 31 having reinforcing members such as, for example, a series of parallel wedge elements 50 (FIGS. 8 and 9) along this inner sidewall.

Reinforcing members are most suited for use when the deck 12 is blow molded from plastic. There are additional reinforcing members in the deck 12. As shown in FIG. 8, a series of recessed ribs 52 extend lengthwise along the underside 12b and a series of recessed ribs 54 extend crosswise along the underside. In the illustartive embodiment, the topside 12a of the creeper 10 has a plurality of ridges 34 therein near the head end 12e. These ridges 34 may be shaped to resist movement of a user as he or she lies on the creeper 10, as well as reinforcing the deck's resistance to bending. The ridges 34 extend lengthwise along the topside 12a of the deck 12 substantially parallel to the axis X. There may also be ridges 36 in the lid 32 extending lengthwise along the external side 36 of the lid 32 substantially parallel to the axis X. All these reinforcing members impart structural rigidity to the deck 12 or lid 32, as the case may be. The creeper 10 is designed so the bottom wall 30a is at least 1 inch from the ground surface when the creeper 10 is being used, and typically is parallel to the ground when the creeper 10 is being used. One embodiment of the creeper 10 is designed to carry a load of at least 250 pounds, with the bottom wall 30a being at least 1 inch above ground level.

In one embodiment, the ridges 34, 36 may be formed from a soft, deformable material such as rubber, such that the ridges 34, 36 provide resistance to the movement of the user when in a supine position, as well as providing cushioned comfort.

The recessed, planar ledge 33 of the tray section 40 is adjacent the open mouth M and is inward thereto, closer to the user's torso and head end 12e than the well 42. The distance d (FIG. 5A) the ledge 33 is from the topside 12a is about 1/16 to about 1/4 inch. This ledge 33 is substantially parallel to the topside 12a. There may be a plurality of indentations 40a in the ledge 33 holding tools. The individual indentations 40a are shaped to the outline of the stored tools such that when an individual tool is placed within an indentation 40a, the tool is frictionally secure within the indentation 40a. The tray section 40 typically is rectangular is shape, although other shapes are acceptable. Typically, the tray section 40 has a surface area of from about 60 to about 80 square inches.

The lid 32 is moveable between an open position and a closed position. In the open position, a user has access to any tools stored on the compartment 30. In the closed position, the lid 32 forms part of the topside 12a of the deck. For example: (a) As shown in FIG. 7, the lid 32 snaps into the opening 30g. (b) Or, as shown in FIGS. 3 and 4, the lid 32 is coupled at one end by a hinge 32b to the deck 12. When in a closed position, an external side 32c of the lid 32 lies flush with the topside 12a of the deck 12. To open the lid 30 depicted in FIG. 7, the lid popped out by pressing against it. To open the lid 30 depicted in FIGS. 3 and 4, a user inserts his or her hand into a hole 38 next to the lid such that he or she can grasp the lid at an unhinged end 32a and pull it open. The hole 38 typically lies adjacent to unhinged end 32a. When the lid 32 is opened, the lid 32 rotates about the hinge 32b, exposing the interior space S compartment 30. In either embodiment, the compartment 30 may be near the foot end 12f of the deck 12 so a user may more easily access the tools stored in the compartment 30.

The creeper 10 may be sold with or without tools, for example, a screwdriver T (only one shown in FIG. 4). When sold with tools, the tools may be stored in the well 42, or in the indentations 40a in the tray section 40, or both. The well 42 comprises a zone where loose tools may be stored, such loose tools not being in any fixed location so they are free to move within the well. The volume of this zone is typically from about 120 to about 160 cubic inches. Examples of loose tools are pressure gauges, screwdrivers, and wrenches.

In one embodiment, the tools are sold with the creeper 10, such that, the tools are stored in the tray section 40, and retained within the indentations 40a until used. For example, a ratchet set may be packaged and sold with the creeper 10, with the ratchet and bits stored within indentations 40a. Loose tools may also be sold with the creeper 10 by simply placing them within the well 42, without any tools being stored within the indentations 40a.

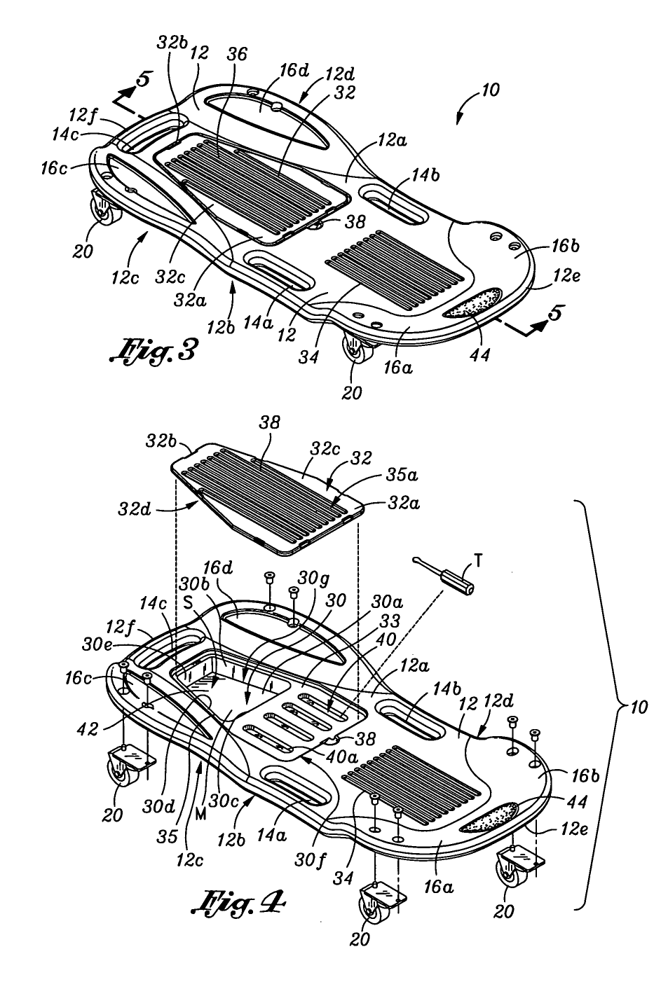

Referring to FIGS. 2, 3 and 4, the creeper 10 includes a rolling mechanism, such as wheels 40 attached to the deck 12 by conventional bolt or screw type fasteners 51. These wheels extend outward from the underside 12b of the deck 12. In one embodiment, the wheels 40 may be located near opposite ends of sides 12c and 12d, at or near the corners of the deck 12. Typically, each wheel 40 is a caster type wheel mounted to swivel, allowing the wheel 40 to turn and point in a desired direction when the creeper 10 is in use. The wheels 40 are high enough so that the bottom wall 30a of the compartment 30 is above ground when the creeper 10 is being used, elevate the deck above ground level a predetermined distance, typically from about 2 to about 5 inches. The wheels are all the same height, so that the creeper 10 when being used is oriented substantially horizontally.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A creeper comprising
a deck including a topside, an underside, and wheels extending outward from the underside,
said wheels elevating the deck above ground level a predetermined distance, and
a compartment that is beneath and connected to the underside, said compartment having sidewalls and a bottom wall forming an interior adapted to hold tools, said compartment having an opening in the topside to provide access to said interior,
said sidewalls having a predetermined height that is less than said predetermined distance so that said bottom wall is above ground level.

2. The creeper of claim 1 where the compartment includes tools.

3. The creeper of claim 2 where the compartment includes a tray section with indentations therein conforming to the shape of individual tools and said individual tools are seated in said indentations.

4. The creeper of claim 1 where the compartment includes a well section and an adjacent tray section with indentations therein conforming to the shape of individual tools adapted to be stored in individual indentations.

5. The creeper of claim 4 where said individual tools are seated in said indentations.

6. The creeper of claim 1 comprising a head end and a foot end, said compartment being closer to the foot end than the head end.

7. The creeper of claim 1 comprising a head end and a foot end, said compartment having one end that tapers inward towards the foot end.

8. The creeper of claim 1 comprising a head end and a foot end with a headrest on the topside near the head end of the deck.

9. The creeper of claim 8 where the headrest is detachably mounted to the deck.

10. The creeper of claim 1 comprising a head end and a foot end and the topside has a surface comprising a pair of contours, one contour on each side of a head rest at the head end, said contours each having a predetermined outline corresponding to one shoulder of a user lying on his or her back on the topside of the deck with his or her head on the headrest.

11. The creeper of claim 1 comprising a head end and a foot end and the deck has opposed sides and the topside has a surface comprising a pair of contours near the foot end, one contour near each opposed side, said contours each having a predetermined outline corresponding to one leg of a user lying on his or her back on the topside of the deck with his or her head on a headrest at the head end.

12. The creeper of claim 1 where the deck has at least one aperture therein that serves as a handle.

13. The creeper of claim 12 where there is an aperture in the deck at a foot end of the deck.

14. The creeper of claim 12 where the deck has opposed sides and there is a pair of apertures in the deck, one near each of said opposed sides.

15. The creeper of claim 1 where the opening is covered with a lid that is moveable between an open position and a closed position.

16. The creeper of claim 15 where the lid is detachably mounted to the deck.

17. The creeper of claim 15 where the lid is mounted to the deck by a hinge member.

18. The creeper of claim 15 where the lid includes a plurality of parallel ridges extending lengthwise.

19. The creeper of claim 15 where an external side of said lid lies substantially flush with the topside of said deck when said lid is in the closed position.

20. The creeper of claim 1 where the deck is substantially longer than wide, having corners with one wheel at each corner.

21. The creeper of claim 20 where the wheels are mounted to swivel.

22. The creeper of claim 1 where the topside of the deck includes a plurality of parallel ridges extending lengthwise.

23. The creeper of claim 1 where the deck and compartment are integral and molded from a plastic material and the deck includes at least one reinforcing member.

24. The creeper of claim 1 where said tools and creeper are sold separately.

25. The creeper of claim 1 where said tools and creeper are packaged together and sold as a single unit at a point-of-sale.

26. The creeper of claim 25 where said tools are stored within said compartment.

27. A creeper comprising
a deck including a topside, an underside, and wheels extending outward from the underside;
said wheels elevating the deck above ground level a predetermined distance and supporting the deck in a substantially horizontal orientation when the creeper is being used,
a compartment located along said underside of said deck including an interior adapted to hold tools, said compartment having an opening in the topside to provide access to said interior and a bottom that is above ground level when the creeper is being used, and
tools stored in said compartment.

28. The creeper of claim 27 where the compartment includes a tray section with indentations therein conforming to the shape of individual tools and said individual tools are seated in said indentations.

29. The creeper of claim 27 where the compartment includes a well section and a tray section with indentations therein conforming to the shape of individual tools adapted to be stored in individual indentations.

30. The creeper of claim 27 comprising a head end and a foot end, said compartment being closer to the foot end than the head end.

31. The creeper of claim 27 comprising a head end and a foot end, said compartment having one end that tapers outward towards the foot end.

32. The creeper of claim 27 where the opening is covered with a lid moveable between an open position and a closed position.

33. The creeper of claim 32 where the lid is detachably mounted to the deck.

34. The creeper of claim 32 where the lid is mounted to the deck by a hinge member.

35. The creeper of claim 32 where an external side of said lid lies substantially flush with the topside of said deck when said lid is in the closed position.

36. The creeper of claim 27 where the deck and compartment are integral and molded from a plastic material and the deck includes at least one reinforcing member.

37. A creeper comprising
a body molded from a plastic material and comprising a deck and a tool compartment adapted to store tools, and
wheels attached to the deck that elevate the deck above ground level a predetermined distance and orient said deck substantially parallel to ground level.

38. The creeper of claim 37 where said body is blow molded and includes a hollow portion.

39. The creeper of claim 37 where tools are stored within said compartment.

40. The creeper of claim 37 where the deck includes a topside and an underside, and said wheels extend outward from the underside, said compartment being beneath the underside and above ground level when the creeper is being used.

41. The creeper of claim 39 where the compartment includes a tray section with indentations therein conforming to the shape of individual tools and said individual tools are seated in said indentations.

42. The creeper of claim 39 comprising a head end and a foot end, said compartment being closer to the foot end than the head end.

43. The creeper of claim 39 where the opening is covered with a lid that is moveable between an open position and a closed position.

44. The creeper of claim 42 where an external side of said lid lies substantially flush with the topside of said deck when said lid is in the closed position.

45. The creeper of claim 37 where the deck is sufficiently rigid to carry a load of 250 pounds with said compartment being above ground level at least 1 inch when carrying said load.

46. The creeper of claim 44 where the deck includes at least one reinforcing member.

47. A creeper comprising
a body blow molded from a plastic material to have a hollow portion,
said body comprising a deck including a topside and an underside and a compartment integral with said deck that has an interior adapted to store tools, said compartment being beneath the underside and having an opening in the topside providing access to said interior of the compartment,
a lid overlying said opening that is moveable between an open position and a closed position, said lid having an external side that lies substantially flush with the topside of said deck when said lid is in the closed position, and
wheels extending outward from the underside that orient the deck substantially parallel to ground level and elevate said deck above ground level a predetermined distance so that a bottom of the compartment is above ground level when the creeper is being used.

48. The creeper of claim 46 where the compartment includes a tray section with indentations therein conforming to the shape of individual tools and said individual tools are seated in said indentations.

49. The creeper of claim 47 comprising a head end and a foot end, said compartment being closer to the foot end than the head end.

50. The creeper of claim 46 where the deck is sufficiently rigid to carry a load of 250 pounds with said compartment being above ground level at least 1 inch when carrying said load.

51. The creeper of claim 49 where the deck includes at least one reinforcing member.

52. A method of merchandising tools with a creeper at a point-of-sale, comprising:
providing said creeper with a compartment,
storing tools within said compartment such that said tools and creeper are sold together as a unit at a point-of-sale.

53. The method of claim 52 where said compartment includes a tray section with indentations therein conforming to the shape of individual tools with said individual tools seated in said indentations.
